(19) United States
(12) Patent Application Publication
(10) Pub. No.: US 2022/0405183 A1
(43) Pub. Date: Dec. 22, 2022

(54) MANAGEMENT SYSTEM AND MANAGEMENT METHOD FOR MANAGING INFORMATION SYSTEM

(71) Applicant: Hitachi, Ltd., Tokyo (JP)

(72) Inventor: Yuki KUSAKABE, Tokyo (JP)

(73) Assignee: Hitachi, Ltd., Tokyo (JP)

(21) Appl. No.: 17/688,178

(22) Filed: Mar. 7, 2022

(30) Foreign Application Priority Data
Jun. 22, 2021 (JP) 2021-102964

(51) Int. Cl. G06F 11/30; G06F 11/07; G06F 11/14

(52) U.S. Cl. CPC G06F 11/3051; G06F 11/0772; G06F 11/0793; G06F 11/142

(57) ABSTRACT

Current configuration information indicates current configuration of an information system. Past configuration information indicates past configuration case information attained from different past configuration cases for the information system. The current configuration information and the past configuration information are each constituted of items each assigned with a bit. A value of each bit assigned to each item indicates one of two states defined in each item. Handling method information associates a relationship between a bit sequence of the current configuration information and a bit sequence of the past configuration case information with a handling method for a configuration error. A management system selects past configuration case information from the past configuration information, selects, from the handling method information, a handling method based on the relationship between the bit sequence of the past configuration case information and the bit sequence of the current configuration information, and presents the selected handling method.

### CLAIM OF PRIORITY

The present application claims priority from Japanese patent application JP2021- 102964 filed on Jun. 22, 2021, the content of which is hereby incorporated by reference into this application.

### BACKGROUND

The present invention relates to managing an information system.

In recent years, IT systems have increased in scale and complexity through the growth of scalable IT systems that can start with small-scale system configurations and can scale all the way up to large-scale system configurations through the addition of devices, as exemplified by the introduction of virtualization techniques, cloud computing, and hyperconverged infrastructure (HCI).

If an IT system is small in scale, software necessary to operate the IT system can be configured by a small number of engineers on the basis of a system design, and thus, such an IT system has low susceptibility to configuration errors for software, and even in the case of configuration errors, the cause thereof can be identified in a short period of time.

However, as a result of the increasingly large scale and complexity of IT systems, the configurations of software necessary to operate such IT systems and the dependencies between pieces of software have become more complex and cumbersome. Additionally, there has been an increasing frequency of cases in which multiple engineers configure software individually according to the engineers' respective roles. Even if the engineers can check areas under their own purview, they cannot check other areas, and thus, as the system increases in scale and the number of individuals involved increases, the number of configuration errors also increases.

As a result, there has been an increase in malfunctions in IT systems resulting from software configuration errors such as inconsistent definitions of dependencies among software configurations and version inconsistencies between existing software and new software throughout the entire IT system. Additionally, more time is required to identify causes for software configuration errors.

An example of a conventional technique is disclosed in Japanese Patent Application Laid-Open Publication No. 2017-111486. In this document, detection of signs of a fault is performed using learning data, and corresponding fault sign detection results are outputted if, upon determining whether the fault is dependent on the software configuration, it is found that the system software configurations are similar during learning and during detection. As a result, it is possible to detect a configuration error even if the software configuration has changed.

### SUMMARY

In managing an information system, in addition to detecting errors in the initial configuration when changing the configuration during operation or newly installing the information system, the handling method for the detected configuration error needs to be efficiently determined and presented.

An aspect of this disclosure is a management system for managing an information system, including: one or more arithmetic devices; and one or more storage devices, wherein the one or more arithmetic devices acquire current configuration information attained from a current configuration of an information system, wherein the one or more storage devices store therein past configuration information and handling method information, wherein the past configuration information indicates past configuration case information attained from different past configuration cases for the information system, wherein the current configuration information and the past configuration information are each constituted of a plurality of items, wherein the plurality of items are each assigned with a bit, wherein a value of each bit assigned to each of the plurality of items indicates one of two states defined in each item, wherein the handling method information associates a relationship between a bit sequence of the current configuration information and a bit sequence of the past configuration case information with a handling method for a configuration error, and wherein the one or more arithmetic devices: select past configuration case information from the past configuration information; select, from the handling method information, a handling method based on the relationship between the bit sequence of the past configuration case information and the bit sequence of the current configuration information; and present the selected handling method.

According to one aspect, the handling method for a configuration error in an information system can be efficiently determined.

### BRIEF DESCRIPTION OF THE DRAWINGS

FIG. 1 illustrates a configuration example of a computer system according to one embodiment of the present specification.

FIGS. 2A and 2B illustrate a configuration example of the configuration information table.

FIG. 3 illustrates a configuration example of the bit sequence conversion table.

FIGS. 4A and 4B illustrate a configuration example of the failed configuration bit sequence table.

FIG. 5 illustrates a configuration example of the handling method presenting table.

FIGS. 6A and 6B illustrate a configuration example of the successful configuration bit sequence table.

FIG. 7 illustrates a configuration example of the difference presenting table.

FIG. 8 is a flowchart illustrating an example of the process to generate the learning model for detecting a configuration error in the information system.

FIG. 9 is a flowchart illustrating an example of the configuration error detection process.

FIGS. 10A and 10B illustrate a configuration example of the examination result table.

FIG. 11 illustrates a flowchart that shows an example of the process to identify the cause of a configuration error by referring to the failed configuration bit sequence table.

FIG. 12 illustrates a flowchart that shows an example of the process to determine a handling method to present by referring to the successful configuration bit sequence table and the difference presenting table.

FIG. 13 illustrates an example of the configuration information of the current information system and the relationship with the handling method presenting table.

FIG. 14 illustrates an example of a GUI image for presenting an examination result and handling method to a user.

### DETAILED DESCRIPTION OF THE EMBODIMENTS

Below, descriptions will be divided into multiple sections or embodiments as necessary for ease of explanation, but unless otherwise noted, the divided sections or embodiments are not unrelated to each other, and one section or embodiment is a modification example, a detail, or an addition, in part or in entirety, to another section or embodiment. Also, in the description below, when referring to the number of elements or the like (including number, value, quantity, range, etc.), unless otherwise noted or if the number is clearly limited to a specific value due to theoretical reasons, the number of elements is not limited to that specific value and may be more or less than the specific value.

This system may be a physical computer system (one or more physical computers), or may be a system built on a computing resource group (plurality of computing resources) such as a cloud platform. A computer system or a computing resource group includes one or more interface devices (e.g., including a communication device and an input/output device), one or more storage devices (e.g., memory (main storage) and auxiliary storage device), and one or more arithmetic units.

If functions are realized through the execution of programs by the arithmetic units, then established processes are performed using storage devices and/or interface devices or the like, as appropriate, and thus, the functions may be regarded as at least a portion of the arithmetic units. Processes described as being performed by functions may be processes performed by a system having arithmetic units. The programs may be installed from program sources. Program sources may be a program distribution computer or a computer-readable storage medium (e.g., a computer-readable non-transitory storage medium), for example. The description of each function is one example, and a plurality of functions may be consolidated as one function, or one function may be split into a plurality of functions.

Below, a method is described in which a configuration error is detected in an information processing (IT) system, and a method for handling the error is presented. A management system according to one embodiment of the present specification predicts the presence or absence of a fault in an information system, with information regarding the configuration (configuration information) attained from the configuration of the information system as input. If a fault is predicted to occur, this signifies that a configuration error that could result in a fault in the information system is predicted to be present.

The configuration information of an information system can, in addition to items indicating static hardware configuration and software configuration, include items regarding execution results from software operation in the information system.

A management system according to one embodiment of the present specification determines a method for handling a fault if a fault is predicted to occur. The management system retains past configuration information and handling method information. The past configuration information stores configuration information attained from different past configuration cases. The configuration information is constituted of a plurality of items and bits are allocated to each item. Each bit indicates one of two states of the corresponding item.

The management system acquires current configuration information according to the current configuration of an information system to be examined, and allocates a bit sequence to the current configuration information. The management system compares bit sequences of the past configuration information and the past configuration cases to bit sequences of the current configuration information, and identifies similar bit sequences.

The handling method information indicates a handling method based on the relationship between the bit sequences of the current configuration information and the bit sequences of the past configuration cases. The management system acquires a handling method based on the relationship between the bit sequences of the current configuration information and the similar bit sequences from the handling method information.

A management system according to one embodiment of the present specification detects configuration errors on the basis of past similar configuration data for initial configurations during initial installation of the information system in addition to configuration changes during operation of the information system, and displays a method for handling the configuration error, thereby preventing a system fault resulting from the configuration error. Also, by allocating a bit sequence to configuration information attained from the configuration of the information system, it is possible to determine the handling method efficiently.

### <System Configuration>

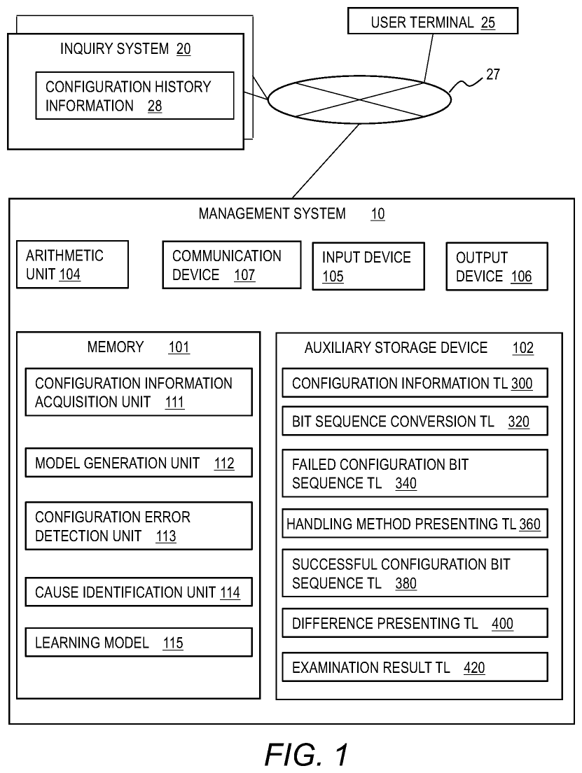

FIG. 1 illustrates a configuration example of a computer system according to one embodiment of the present specification. The computer system includes a management system 10, inquiry systems 20, and a user terminal 25 that are connected to each other via a network 27 to allow communication therebetween. A user can operate the user terminal 25 to issue a request to the management system 10 to examine the configuration of the target information system.

Each inquiry system 20 stores configuration history information 28. The configuration history information 28 indicates the configuration information of various information systems and the presence or absence of a fault in the information systems. The configuration history information 28 accumulates new information as needed. The configuration history information 28 can be acquired from information systems that are or were actually in use, or can be acquired from an inquiry from an information system user regarding a fault, for example.

The management system 10 analyzes the configuration of the information system designated by the user according to a request from the user, and predicts the presence or absence of a fault resulting from a configuration error. If it is predicted that a fault will occur, the management system 10 transmits information to that effect to the user terminal 25. As a result, a user of the information system can be informed of configuration errors in the building of a new information system or in updating an existing information system, and it is possible to prevent system faults in advance.

In addition to a server system, a personal computer or a virtual information processing device on a cloud computing system can be used for the management system 10. The management system 10 includes a memory 101 (primary storage device) constituted of a volatile storage element such as RAM, and an auxiliary storage device 102 constituted of an appropriate non-volatile storage element such as a solid-state drive (SSD) or a hard disk drive. The management system 10 additionally includes an arithmetic unit 104 that is a CPU or the like that executes programs stored in the auxiliary storage device 102 by loading such programs to the memory 101 or the like to perform integrated control of the device state, and performs various types of determination, computation, and control processing.

The functions of the management system 10 are implemented by the arithmetic unit 104 executing the programs. FIG. 1 shows programs 111 to 114 that are loaded to the memory 101 in order to be executed by the arithmetic unit 104. Specifically, the arithmetic unit 104 executes a configuration information acquisition unit 111, a model generation unit 112, a configuration error detection unit 113, a cause identification unit 114, and a learning model 115. By executing these programs, the arithmetic unit 104 operates as the corresponding functional units. Details regarding the operation of these programs will be described later.

Additionally, the management system 10 includes a communication device 107 for connecting to an appropriate network and exchanging data. The management system 10 may include an input device 105 such as a keyboard, a mouse, or a touch panel that receives input operations from the user, and an output device 106 such as a display that displays processing results to the user. If the management system 10 operates as a standalone machine, then the communication device 107 is not needed.

The auxiliary storage device 102 stores therein the programs for executing functions necessary for the management system 10 as well as data necessary for various processes. Specifically, the auxiliary storage device 102 stores a configuration information table 300 (TL), a bit sequence conversion table 320, a failed configuration bit sequence table 340, a handling method presenting table 360, a successful configuration bit sequence table 380, a difference presenting table 400, and an examination result table 420.

The failed configuration bit sequence table 340 and the successful configuration bit sequence table 380 are examples of past configuration information, and the handling method presenting table 360 and the difference presenting table 400 are examples of handling method information. As will be described later, the configuration information shows past configuration case information attained from different past configuration cases for information systems. The handling method information associates the relationship between the bit sequences of the configuration information of the system under examination and the bit sequences of the past configuration case information, with the handling method for the configuration error.

The auxiliary storage device 102 may be an internal device of the management system 10 or may be included in network storage such as network-attached storage (NAS) used in a company or an organization, web storage, or the like.

The user terminal 25 and the inquiry system 20 may have a computer configuration like the management system 10. That is, the user terminal 25 and the inquiry system 20 can include an input device, an output device, and a communication device in addition to one or more arithmetic units and one or more storage devices. Some of the constituent elements may be omitted. A configuration may be adopted in which the user terminal 25 is a personal computer or a wearable computer and the inquiry system 20 is a server system, for example.

### <Management Information>

Below, the management information stored in the management system 10 will be described in detail. Additionally, an example of management information for detecting a fault in a storage system will be described below. The management system of the present specification can alternatively be applied to an information system other than a storage system.

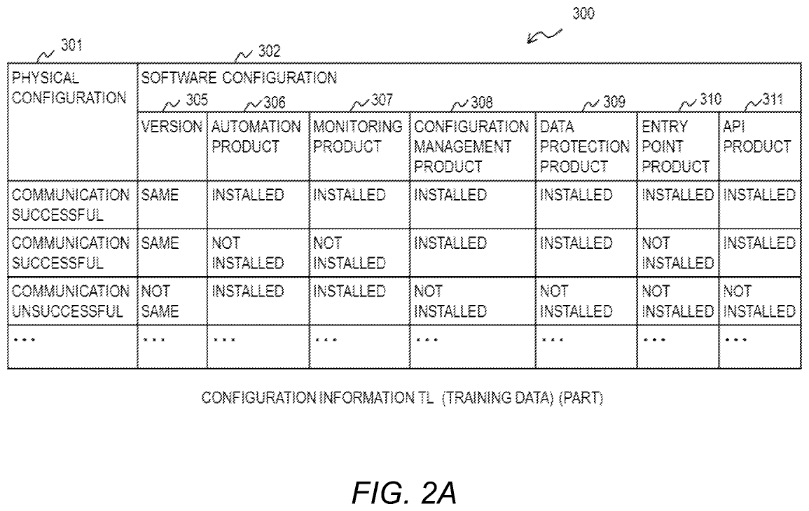

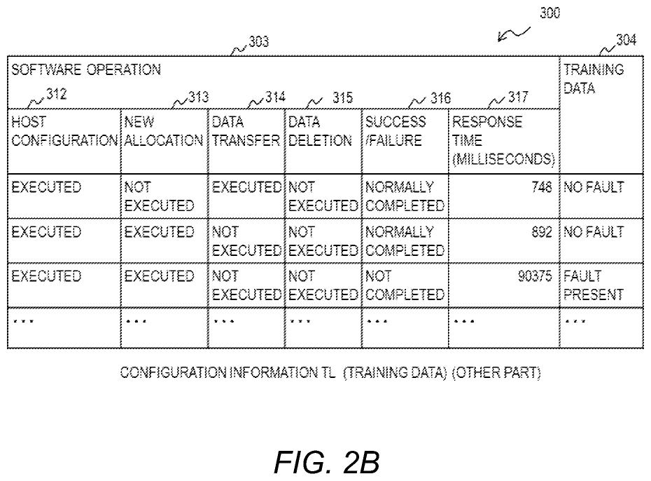

FIGS. 2A and 2B illustrate a configuration example of the configuration information table 300. FIG. 2A and FIG. 2B illustrate the left part and the right part of the configuration information table 300, respectively. As will be described later, the configuration information table 300 stores training data of the learning model 115 (also referred to as a machine learning model or a model) that predicts the occurrence of a fault in the information system. The configuration information table 300 indicates information regarding the configurations of the plurality of actual information systems and the presence or absence of a fault. The management system 10 can acquire information from the configuration history information 28 of the inquiry system 20 and include the information in the configuration information table 300.

The configuration information table 300 indicates information representing the configuration of the information systems or information attained from the configuration. In the example of FIGS. 2A and 2B, the configuration information table 300 has a physical configuration column 301, a software configuration column 302, a software operation column 303, and a training data column 304. Each record in the configuration information table 300 indicates information pertaining to the configuration of one information system and the presence or absence of a fault. In the example of FIGS. 2A and 2B, a plurality of records can indicate information on different operations of a single information system.

Each record is supervised data for one instance of a prediction process of the model 115 for predicting the occurrence of a fault. Supervised data is a combination of input data to the model 115 and training data. The values of the physical configuration column 301, the software configuration column 302, and the software operation column 303 are the input data for training the fault occurrence prediction model 115, and the value of the training data column 304 is the training data.

The physical configuration column 301 indicates information regarding the physical configuration of the information system. In the example of FIGS. 2A and 2B, the physical configuration column 301 indicates the presence or absence of communication between devices within the information system. In the case of an information system having many devices, a case in which communication is possible between all devices is determined as “communication successful” and a case in which communication is unsuccessful between any of the device pairs is determined as “communication unsuccessful,” for example. The presence or absence of communication may be determined according to another method.

The software configuration column 302 indicates information regarding the software configuration of the information system. In the example of FIGS. 2A and 2B, the software configuration column 302 indicates whether a specific software product (program) has been installed in the information system, or whether the version of the product satisfies designated conditions.

In the example of FIGS. 2A and 2B, the software configuration column 302 includes a version column 305, an automation product column 306, a monitoring product column 307, a configuration management product column 308, a data protection product column 309, an entry point product column 310, and an API product column 311.

The version column 305 indicates whether or not the combination of versions of software products installed in the information system match any preset combinations. It is possible, for example, to determine whether all installed software products are at the latest versions. The automation product column 306, the monitoring product column 307, the configuration management product column 308, the data protection product column 309, the entry point product column 310, and the API product column 311 respectively indicate whether the corresponding software products are installed.

An automation product creates a template to automate the configuration of software. A monitoring product monitors the state of the information system. A configuration management product enables the user to perform initial configurations. A data protection product protects the data of the information system. An entry point product combines other software products and serves as an entry point for software products. The entry point product enables configuration of single sign-on.

The software operation column 303 indicates information regarding operation of the software product indicated by the software configuration column 302. Specifically, the software operation column 303 indicates whether or not a specific software operation has been executed, the success or failure of execution of the software operation, and the response time of the information system for execution of the software operation.

In the example of FIGS. 2A and 2B, the software operation column 303 has a host configuration column 312, a new allocation column 313, a data transfer column 314, a data deletion column 315, a success/failure column 316, and a response time column 317. The host configuration column 312, the new allocation column 313, the data transfer column 314, and the data deletion column 315 respectively indicate whether or not the corresponding software operations have been executed.

The host configuration column 312, for example, indicates whether or not single sign-on has been configured. If single sign-on has been configured, it is possible to operate all software products through a single authentication process. The new allocation column 313, the data transfer column 314, and the data deletion column 315 respectively indicate the execution of operations for the allocation of new volumes, the transfer of data stored in the volumes, and the deletion of data in the volumes.

The success/failure column 316 indicates the success or failure of a software operation executed for any one of the new allocation column 313, the data transfer column 314, and the data deletion column 315. The response time column 317 indicates the response time of the information system for a software operation executed for any one of the new allocation column 313, the data transfer column 314, and the data deletion column 315.

The training data column 304 indicates whether or not a fault has occurred in the state indicated by each record. As will be described later, the values of the physical configuration column 301, the software configuration column 302, and the software operation column 303 are used as input for training the fault occurrence prediction model 115, and the value of the training data column 304 is used as the training data for training.

A fault in the information system can occur due to a configuration error in the information system. In order to accurately predict the occurrence of a fault in the information system, it is important to refer to items indicating configuration errors that are the cause for the fault. By referring to such items, it is possible to more accurately predict the cause for the fault.

For example, in installing a new information system, a configuration error can occur in the physical connections between the devices. Configuration errors that could occur include poor cable contact and faulty wiring, for example. The perspectives from which to detect such configuration errors include the presence or absence of communication between devices and the response time.

Additionally, a configuration error can occur in software operation. A configuration error that can occur is a defect in the preconfiguration of coordination between software products, for example. The perspectives from which to detect such configuration errors include the configuration of single sign-on, the types of software products installed, and the software product versions.

An error can also occur in the physical connections between the devices in a currently operating information system. A configuration error that can occur is a physical connection error when installing new devices, for example. The perspectives from which to detect such configuration errors include the presence or absence of communication between devices and the response time.

Additionally, an error can occur in software operation. Configuration errors that can occur include a defect in the coordination between products and an error in the input (configuration) of tasks, for example. The perspectives from which to detect such configuration errors include the types of software products installed, the software operation types, and the success or failure of execution of the software operations.

Items of the configuration information table 300 are configured from such perspectives. As described above, by combining a plurality of check items, it is possible to determine the presence or absence of a configuration error, taking into consideration user operation. Specifically, by including items for the physical configuration and the software configuration, it is possible to suitably determine configuration errors in the information system that executes software in a plurality of devices. Additionally, the items for the software operation enable more suitable determination of configuration errors. The items of the configuration information shown in FIGS. 2A and 2B constitute one example; some of the items may be omitted and other items may be added.

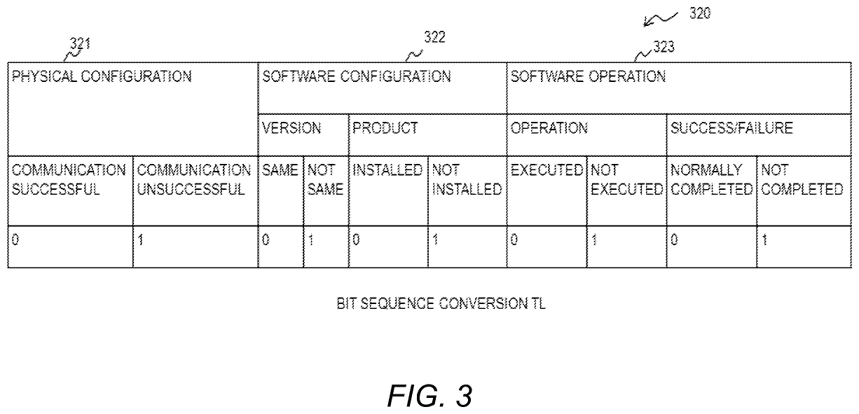

FIG. 3 illustrates a configuration example of the bit sequence conversion table 320. The bit sequence conversion table 320 associates the respective values of the columns in the configuration information table 300 with bit values (0 or 1). The value of each bit indicates one of two states defined in each item. In this manner, it is possible to represent the configuration information of the information system by a bit sequence. As will be described later, it is thus possible to efficiently estimate the causes for faults.

In the example of FIG. 3, the bit sequence conversion table 320 has a physical configuration column 321, a software configuration column 322, and a software operation column 323. These correspond, respectively, to the physical configuration column 301, the software configuration column 302, and the software operation column 303 of the configuration information table 300.

The physical configuration column 321 allocates “0” and “1” respectively for “communication successful” and “communication unsuccessful” between devices. The software configuration column 322 allocates “0” and “1” respectively for “same” and “not same” regarding a combination of versions of the software products and the defined combination. The software configuration column 322 allocates “0” and “1” respectively for “installed” and “not installed” regarding software products. The software operation column 323 allocates “0” and “1” respectively for “executed” and “not executed” regarding operations.

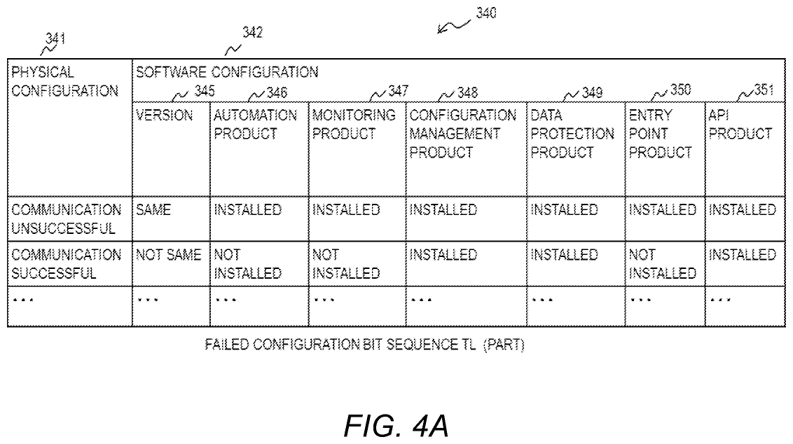

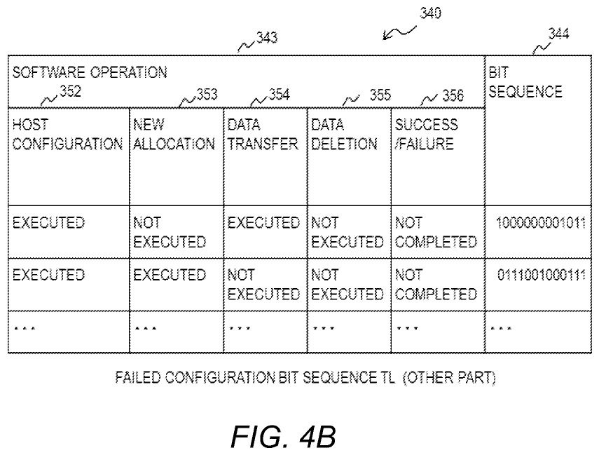

FIGS. 4A and 4B illustrate a configuration example of the failed configuration bit sequence table 340. FIG. 4A and FIG. 4B illustrate the left part and the right part of the failed configuration bit sequence table 340, respectively. The failed configuration bit sequence table 340 indicates configuration information of information systems where a fault occurred in the past. That is, the failed configuration bit sequence table 340 indicates information regarding past failed configuration cases. The management system 10 extracts records where a fault has occurred from the configuration information table 300 and stores the records in the failed configuration bit sequence table 340. As will be described later, the failed configuration bit sequence table 340 is referred to in order to determine information to present to the user when a fault is detected in the current information system under examination.

The records of the failed configuration bit sequence table 340 have a configuration that omits the response time and the training data from the records of the configuration information table 300, and that adds bit sequences. Specifically, the failed configuration bit sequence table 340 has a physical configuration column 341, a software configuration column 342, a software operation column 343, and a bit sequence column 344.

The software configuration column 342 includes a version column 345, an automation product column 346, a monitoring product column 347, a configuration management product column 348, a data protection product column 349, an entry point product column 350, and an API product column 351. The software operation column 343 has a host configuration column 352, a new allocation column 353, a data transfer column 354, a data deletion column 355, and a success/failure column 356.

As described above, the response time is omitted from the failed configuration bit sequence table 340. This is because the response time is a value represented by multiple bits instead of one bit. As a result, it is possible to suitably estimate the cause of a fault and present a suitable handling method. In another example, a configuration may be adopted in which whether or not the response time exceeds a threshold is represented by one bit and this bit is included in the failed configuration bit sequence table 340.

The bit sequence column 344 stores a bit sequence representing content of the physical configuration column 341, the software configuration column 342, and the software operation column 343 of each record. The management system 10 refers to the bit sequence conversion table 320 to determine the bit values of items of records constituting each information system, and stores the bit sequence constituted of the bit values in the bit sequence column 344.

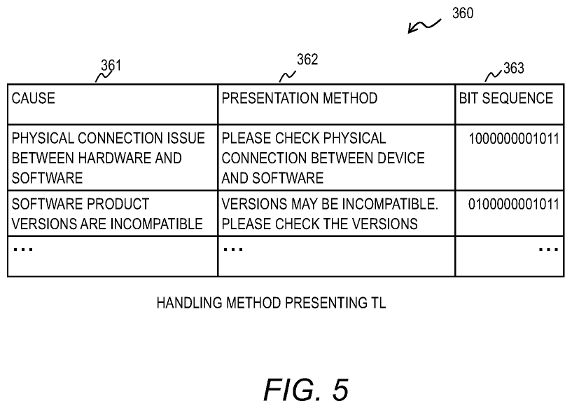

FIG. 5 illustrates a configuration example of the handling method presenting table 360. The handling method presenting table 360 indicates the cause of the fault and the presentation content of handling method for each record of the failed configuration bit sequence table 340. The handling method presenting table 360 has a cause column 361, a presentation content column 362, and a bit sequence column 363. The cause column 361 indicates the cause for a detected (predicted) fault, and the presentation content column 362 indicates information to be presented to the user in order to resolve the cause. The bit sequence column 363 indicates a bit sequence within the bit sequence column 344 of the failed configuration bit sequence table 340.

The management system 10 searches the failed configuration bit sequence table 340 for a bit sequence of the configuration of the current information system (current configuration) under examination. When the same bit sequence is detected in the failed configuration bit sequence table 340, the management system 10 acquires and presents to the user the cause and handling method corresponding to the bit sequence. The cause for the fault may be omitted.

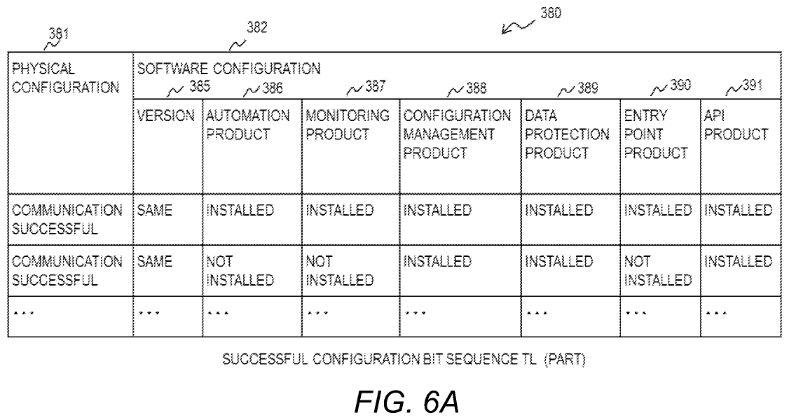

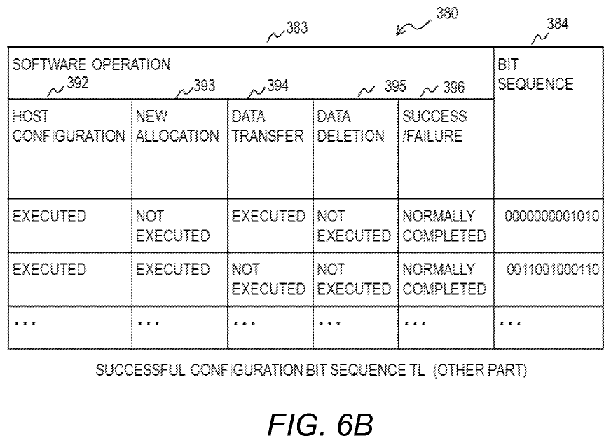

FIGS. 6A and 6B illustrate a configuration example of the successful configuration bit sequence table 380. FIG. 6A and FIG. 6B illustrate the left part and the right part of the successful configuration bit sequence table 380, respectively. The successful configuration bit sequence table 380 indicates configuration information of information systems where a fault has not occurred in the past. That is, the successful configuration bit sequence table 380 indicates information regarding past successful configuration cases. The management system 10 extracts records where a fault has not occurred from the configuration information table 300 and stores the records in the successful configuration bit sequence table 380. As will be described later, the successful configuration bit sequence table 380 is referred to in order to predict the handling cause when a fault is detected in the current information system under examination.

The records of the successful configuration bit sequence table 380 have a configuration that omits the response time and the training data from the records of the configuration information table 300, and that adds bit sequences. Specifically, the successful configuration bit sequence table 380 has a physical configuration column 381, a software configuration column 382, a software operation column 383, and a bit sequence column 384.

The software configuration column 382 includes a version column 385, an automation product column 386, a monitoring product column 347, a configuration management product column 388, a data protection product column 389, an entry point product column 390, and an API product column 391. The software operation column 383 has a host configuration column 392, a new allocation column 393, a data transfer column 394, a data deletion column 395, and a success/failure column 396.

As described above, the response time is omitted from the successful configuration bit sequence table 380. This is because the response time is a value represented by multiple bits instead of one bit. As a result, it is possible to suitably estimate the cause of a fault and present a suitable handling method. In another example, a configuration may be adopted in which whether or not the response time exceeds a threshold is represented by one bit and this bit is included in the successful configuration bit sequence table 380.

The bit sequence column 384 stores a bit sequence representing content of the physical configuration column 381, the software configuration column 382, and the software operation column 383 of each record. The management system 10 refers to the bit sequence conversion table 320 to determine the bit values of items of records constituting each information system, and stores the bit sequence constituted of the bit values in the bit sequence column 384.

If the same configuration information as the current information system where a fault was detected is not present in the failed configuration bit sequence table 340, the management system 10 refers to the successful configuration bit sequence table 380. The management system 10 extracts a record similar to the configuration information of the current information system from the successful configuration bit sequence table 380. In one example, the most similar record is selected.

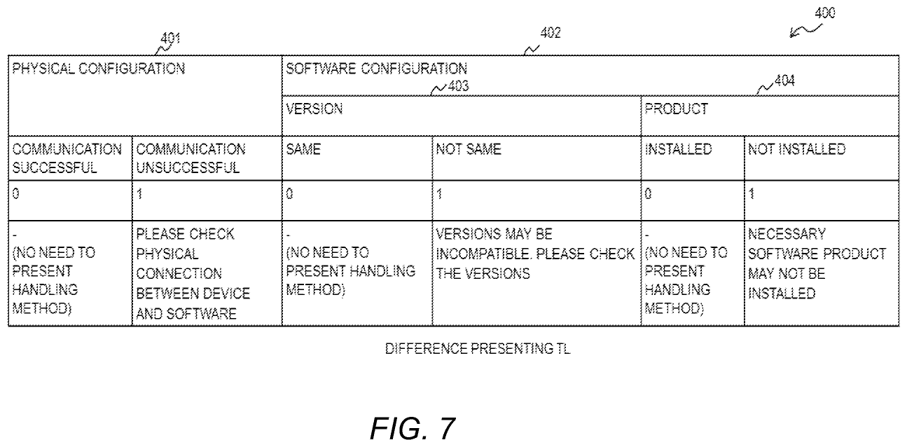

FIG. 7 illustrates a configuration example of the difference presenting table 400. The difference presenting table 400 indicates a handling method corresponding to the difference from the past successful configuration selected from the successful configuration bit sequence table 380. The difference presenting table 400 has a physical configuration column 401 and a software configuration column 402. The software configuration column 402 has a version column 403 and a product column 404.

The physical configuration column 401 indicates content to be presented if the difference is “communication successful” versus “communication unsuccessful.” The version column 403 indicates content to be presented if the difference is “same” versus “not same.” The product column 404 indicates content to be presented if the difference is “installed” versus “not installed” regarding software products.

If “communication [is] successful,” the versions are the “same,” or the products are “installed,” then a handling method need not be presented, and the handling method is not presented to the user. If “communication [is] unsuccessful,” the versions are “not [the] same,” or the products are “not installed,” then handling methods corresponding thereto are presented.

In one embodiment of the present specification, if the same configuration information as the configuration information of the current information system where a fault was detected cannot be found in the failed configuration bit sequence table 340, the management system 10 selects the most similar configuration information from the successful configuration bit sequence table 380. The management system 10 compares the bit sequence of the configuration information of the current information system to the bit sequence of the selected configuration information, and detects the difference between the bit sequence of the configuration information of the current information system as compared to the bit sequence of the selected configuration information.

As described above, if the bit sequence of the current information system indicates “communication unsuccessful” and the bit sequence of the selected configuration information indicates “communication successful,” then the handling method for “communication unsuccessful” in the physical configuration column 401 is selected. Alternatively, if the bit sequence of the current information system indicates that a given software product is “not installed” and the bit sequence of the selected configuration information indicates that the product is “installed,” then the handling method for “not installed” in the product column 404 is selected. If differences are present over multiple bits, then all handling methods may be selected and presented, for example.

### <Processing by Management System>

Below, an example of the processing by the management system 10 will be explained. The management system 10 predicts the presence or absence of a fault resulting from a configuration error of the information system, and if a fault is predicted to occur, presents a handling method for the fault. This allows the user of the information system to fix the configuration error, and to build an information system free from configuration errors.

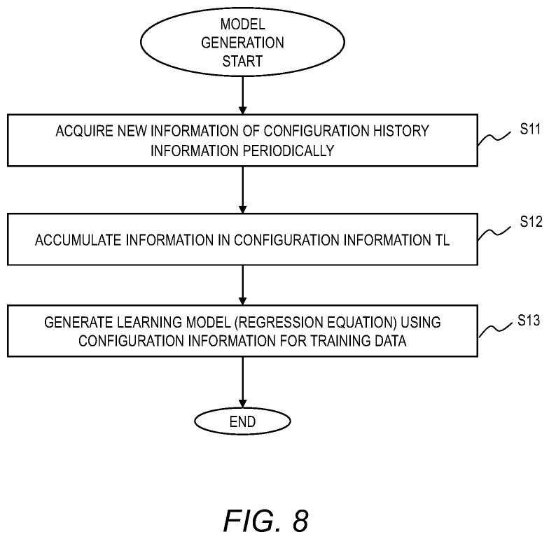

First, generation of the fault occurrence prediction model 115 will be explained. Generation of the model 115 includes further training and updating the existing trained model. FIG. 8 is a flowchart illustrating an example of the process to generate the learning model 115 for detecting a configuration error in the information system. The management system 10 generates the learning model 115 by updating parameters of the learning model 115 through training with the training data stored in the configuration information table 300.

As illustrated in FIG. 8, the configuration information acquisition unit 111 acquires new information from the configuration history information 28 of the inquiry system 20 periodically (S11), and stores the new information in the configuration information table 300 (S12).

The model generation unit 112 trains the learning model 115 with training data stored in the configuration information table 300 (S13). For example, when the amount of data added to the configuration information table 300 reaches a prescribed value, the model generation unit 112 may start a new training on the learning model 115. The learning model 115 may alternatively be trained every time after new data is added. In one embodiment of the present specification, the learning model 115 is a regression equation represented by the formula below.

$$y = {{\sum }^{n}}_{k = 1} {β}_{k} {x}_{k} + {β}_{0} \qquad Formula 1$$

y is an output value (target variable) of the learning model 115, and the right-hand side is the arithmetic operation by the learning model 115. β₀ and βₖ are the parameters to be updated by training. xₖ is an explanation coefficient inputted, and is the k-th bit value (0 or 1) of the bit sequence representing the configuration of the information system. k is a natural number. The model generation unit 112 converts each record of the configuration information table 300, referring to the bit sequence conversion table 320.

As described above, the bit sequence conversion table 320 defines the value of each item of the configuration information record as 0 to 1. For example, the top record in the failed configuration bit sequence table 340 will be explained. The physical configuration column 341 indicates “communication unsuccessful”, and thus the first bit is 1. The version column 345 indicates “same”, and thus the second bit is 0.

Because all software products have already been installed, the corresponding bits are all 0. In the software operation, the host configuration column 352 and the data transfer column 354 indicates “executed”, and thus, the corresponding bits are 0. The new allocation column 353 and the data deletion column 355 are “not executed”, and thus the corresponding bits are 1. Lastly, the success/failure column 356 indicates “not completed”, and thus the last corresponding bit is 1.

The learning model 115 calculates the product Σβk×k of the inputted bit sequence and the parameters, and adds a bias β₀ to the product. The model generation unit 112 updates the parameters of the learning model 115 such that the output value y of a successful configuration case where no fault has occurred becomes small and the output value y of a failed configuration case where a fault has occurred becomes large.

The model generation unit 112 further determines a threshold value for the output value y. If the output value exceeds the threshold value, it is determined that a configuration error is present in the information system, and a fault is predicted to occur. The model generation unit 112 refers to the training data of the teaching data, and determines the threshold value for the output value y such that the determination result using the learning model 115 indicates the highest percentage of correct answers. This regression equation is merely an example. Other regression equations may be used, or the learning model 115 may have configurations differing from regression equation.

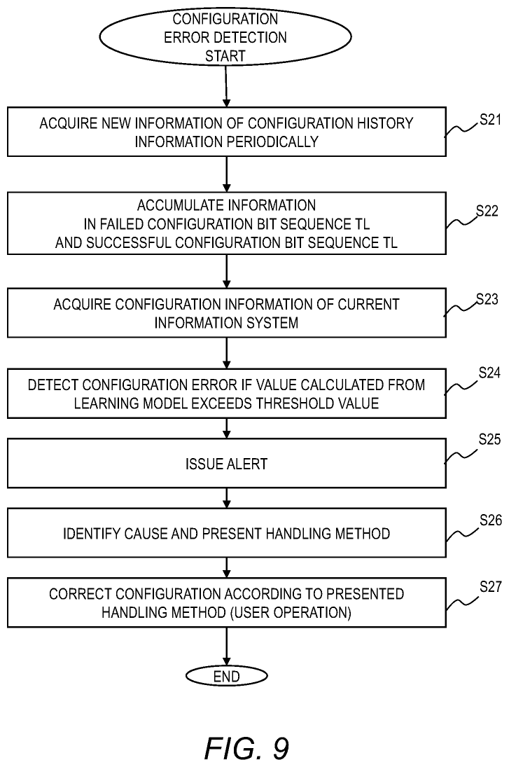

Next, the configuration error detection process in the current information system by the management system 10 will be explained. FIG. 9 is a flowchart illustrating an example of the configuration error detection process. The management system 10 detects a configuration error by inputting the configuration information of the current information system designated by a user into the learning model 115. Upon detecting a configuration error, the management system 10 determines a handling method for the configuration error, and presents the handling method to the user.

As illustrated in FIG. 9, the configuration information acquisition unit 111 acquires new information from the configuration history information 28 of the inquiry system 20 periodically (S21). The configuration information acquisition unit 111 refers to the bit sequence conversion table 320, generates a bit sequence for each of the acquired cases, and assigns the bit sequence to each case. The configuration information acquisition unit 111 stores failed configuration cases of the new information in the failed configuration bit sequence table 340, and stores successful configuration cases in the successful configuration bit sequence table 380 (S22).

The configuration information acquisition unit 111 acquires configuration information of the current information system under examination (S23). The configuration information acquisition unit 111 accepts designation of the information system from the user terminal 25, for example. The configuration information acquisition unit 111 acquires configuration information of the information system from the software products in the applicable information system. In another example, the configuration information acquisition unit 111 may display a GUI image for inputting configuration information in a display device of the user terminal 25.

The configuration information acquisition unit 111 acquires configuration information of the system under examination, and stores the configuration information in the auxiliary storage device 102. At this time, the configuration information acquisition unit 111 generates a bit sequence for the inputted configuration information, referring to the bit sequence conversion table 320, and assigns the bit sequence.

Upon receiving an instruction from the user, the management system 10 performs an examination on the designated information system (S24). Specifically, the configuration error detection unit 113 acquires the bit sequence of the configuration information of the system under examination, which was designated by the user, and inputs the bit sequence into the trained learning model 115. The learning model 115 outputs a value corresponding to the inputted configuration information bit sequence. The configuration error detection unit 113 compares the outputted value with the threshold value, and predicts the presence or absence of a fault in the target information system. If the value exceeds the threshold value, then a fault is predicted to occur, that is, a configuration error that could result in a fault is found.

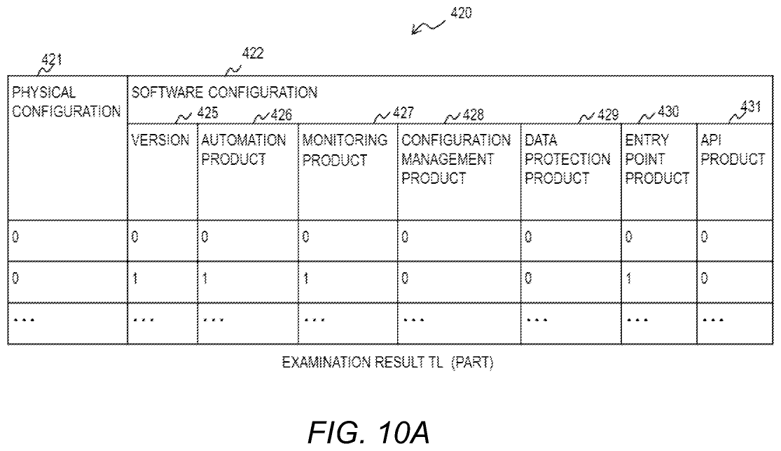

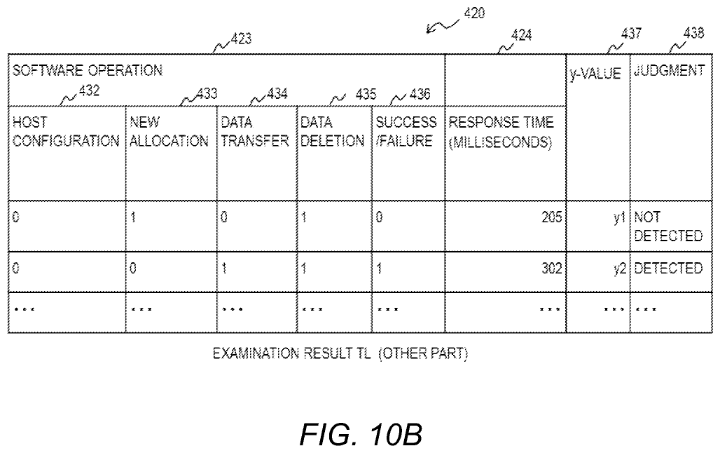

The configuration error detection unit 113 stores the examination result in the examination result table 420. FIGS. 10A and 10B illustrate a configuration example of the examination result table 420. FIG. 10A and FIG. 10B illustrate the left part and the right part of the examination result table 420. The examination result table 420 stores therein the output values and judgment results of the learning model 115 as well as the configuration information of the information system under examination.

Specifically, the examination result table 420 has a physical configuration column 421, a software configuration column 422, a software operation column 437, a response time column 424, a y-value column 437, and a judgment column 438.

The software configuration column 422 includes a version column 425, an automation product column 426, a monitoring product column 427, a configuration management product column 428, a data protection product column 429, an entry point product column 430, and an API product column 431. The software operation column 423 has a host configuration column 432, a new allocation column 433, a data transfer column 434, a data deletion column 435, and a success/failure column 436.

In the physical configuration column 421, the software configuration column 422, and the software operation column 423, a value of each item is shown as a bit value (0 or 1). The response time column 424 shows a numerical value (milliseconds) that represents the response time of the software operation. The y-value column 437 shows an output value of the learning model 115 for each of the configuration information records. The judgment column 438 shows a judgment result of whether a fault (configuration error) is present or absent for each of the configuration information records.

Returning to FIG. 9, if the output value of the learning model 115 is equal to or smaller than the threshold value, then it is determined that a configuration error is not present. The configuration error detection unit 113 transmits information to that effect to the user terminal 25. On the other hand, if a configuration error is detected, then the configuration error detection unit 113 transmits an alert to that effect to the user terminal 25 (S25).

Further, the cause identification unit 114 identifies a cause predicted to result in the fault, and determines a handling method for the cause. The cause identification unit 114 outputs the corresponding handling method to the user terminal 25 to present it to the user (S26). The user fixes the configuration of the information system in accordance with the presented handling method (S27). This way, it is possible to achieve an information system with a normal configuration free from configuration errors.

Below, a process performed by the management system 10 to identify the cause of a configuration error detected in the information system, and select and present a handling method for the cause will be explained. The cause identification unit 114 identifies the error cause and selects a handling method for the cause, referring to the failed configuration bit sequence table 340 or the successful configuration bit sequence table 380. The cause identification unit 114 refers to the successful configuration bit sequence table if unable to identify the cause of the error in the failed configuration bit sequence table 340.

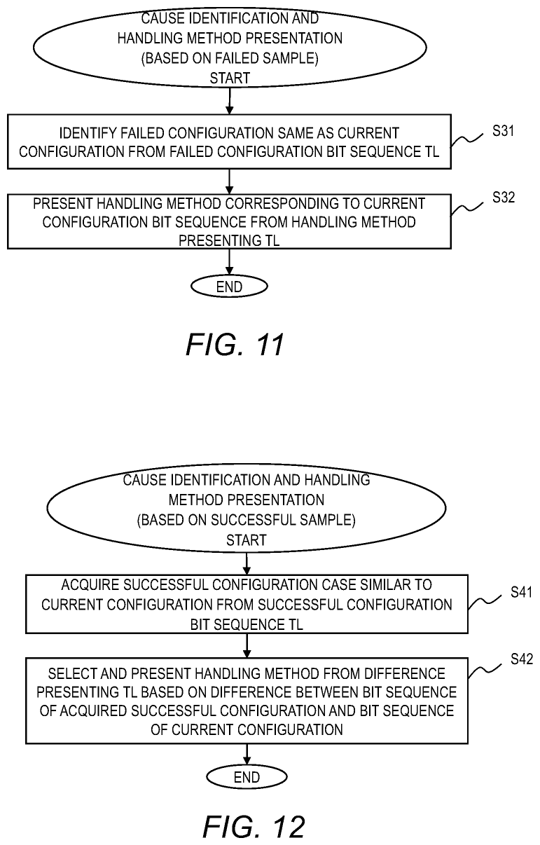

First, the cause identification process based on the failed configuration bit sequence table 340 will be explained. FIG. 11 illustrates a flowchart that shows an example of the process to identify the cause of a configuration error by referring to the failed configuration bit sequence table 340. The cause identification unit 114 identifies, in the failed configuration bit sequence table 340, a failed configuration case having the same configuration as the current information system (S31).

Specifically, the cause identification unit 114 searches the failed configuration bit sequence table 340 for the same bit sequence as the configuration information bit sequence of the current information system. The same bit sequence means a bit sequence having the highest degree of similarity. If the same bit sequence does not exist, then this flow is terminated. If the same bit sequence exists in the failed configuration bit sequence table 340, the cause identification unit 114 proceeds to the next step S32.

In Step S32, the cause identification unit 114 acquires a corresponding handling method from the handing method presenting table 360, and presents the method to the user. Specifically, the cause identification unit 114 searches the handling method presenting table 360 for the configuration bit sequence of the current information system, and acquires a record of the same bit sequence. This record indicates the cause and handling method for the configuration error. The cause identification unit 114 transmits an explanation of the cause and handling method indicated by the acquired record to the user terminal 25 so that they are displayed in the display device.

As described above, by identifying a case having the same configuration as the current configuration in the past failed configuration cases, and presenting a handling method associated with the case, a more appropriate handling method can be presented. Also, by indicating the configuration information of the information system as a bit sequence, a failed configuration case of the same bit sequence can be found efficiently. In this example, the cause and handling method are separated, but the content of the presented handling method is not limited to this. For example, the information shown in the cause column 361 of the handling method presenting table 360 in this example may be presented to a user as a handling method.

If the current configuration bit sequence does not exist in the failed configuration bit sequence table 340, then the cause identification unit 114 refers to the successful configuration bit sequence table 380 and the difference presenting table 400 to determine a handling method to present. FIG. 12 illustrates a flowchart that shows an example of the process to determine a handling method to present by referring to the successful configuration bit sequence table 380 and the difference presenting table 400.

The cause identification unit 114 acquires, from the successful configuration bit sequence table 380, a successful configuration case similar to the current information system (S41). The degree of similarly can be represented as a ratio of bits that match the successful configuration bit sequence (match rate) to the bit sequence of the current information system, for example. The cause identification unit 114 selects a successful configuration case with the highest degree of similarity. In another example, a successful configuration case with the degree of similarity exceeding the threshold value may be selected, and if there are a plurality of successful configuration cases having the highest match rate (degree of similarity), all of them may be selected.

Next, the cause identification unit 114 selects information of the corresponding handling method from the difference presenting table 400, based on the difference (bit) between the bit sequence of the acquired successful configuration case and the bit sequence of the current configuration, and presents the information to the user (S42). Specifically, the cause identification unit 114 identifies a bit in the bit sequence of the current configuration that has a value differing from the bit sequence of the selected successful configuration case. The cause identification unit 114 acquires, from the difference presenting table 400, the item of the identified bit and information of a handling method indicated by the value thereof.

For example, if the differing bit is the physical configuration bit, and the current configuration bit value is 1, then the handling method for “communication unsuccessful” in the physical configuration column 401 is selected. If the differing bit is a bit indicating whether any software product in the software configuration has been installed or not, and the current configuration bit value is 1, then the handling method for “not installed” in the product column 404 is selected. If a plurality of differing bits indicate different handling methods, respectively, those handling methods may all be selected, for example. The cause identification unit 114 sends the acquired information of the handling method to the user terminal 25 so that information is displayed in the display device.

As described above, by identifying a successful configuration case similar to the current configuration and determining a handling method based on the difference therebetween, it is possible to identify and present a handling method even when a failed configuration case that matches the current configuration does not exist. By referring to the failed configuration case first, more appropriate handling methods can be presented. In one embodiment of the present specification, one of the failed configuration bit sequence table 340 and the successful configuration bit sequence table 380 may be omitted.

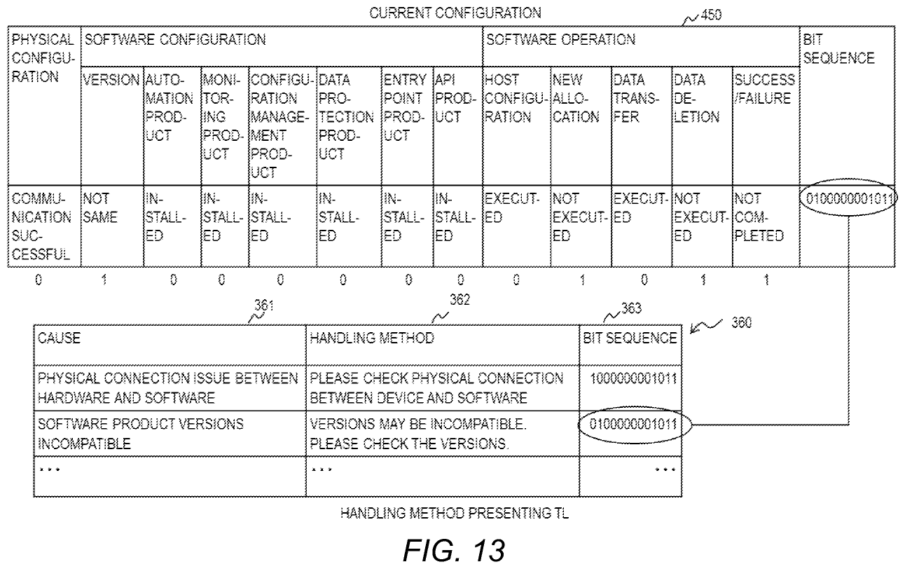

Below, a more specific example will be explained. FIG. 13 illustrates an example of the configuration information 450 of the current information system and the relationship with the handling method presenting table 360. In the configuration information 450, the physical configuration is “communication successful”, the version is “not same”, all products from the automation product to API product are all “installed”, the host configuration is “executed”, the new allocation is “not executed”, the data transfer is “executed”, the data deletion is “not executed” and the success/failure is “not completed”. Based on the bit sequence conversion table 320, the bit sequence corresponding to the values of those items is “0100000001011”.

The bit sequence “0100000001011” matches the bit sequence of the second record from the top in the handling method presenting table 360. Thus, the handing method indicated by this record “Versions may be incompatible. Please check the versions” is presented.

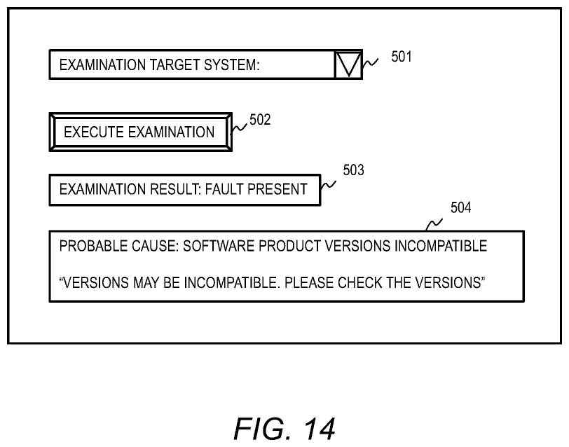

FIG. 14 illustrates an example of a GUI image for presenting an examination result and handling method to a user. The GUI image is displayed in the display device of the user terminal 25, for example. The user designates the information system to be examined in the section 501. The management system 10 sends a query to the designated information system, and acquires configuration information.

When the user selects the examination execution button 502, the management system 10 performs an examination on the designated information system. Upon detecting a configuration error, the management system 10 displays an alert indicating the error in the section 503. Furthermore, the management system 10 identifies a handling method for the current configuration with which the configuration error was detected, and displays the handling method in the GUI image.

The present invention is not limited to the above-described embodiments but includes various modifications. The above-described embodiments are explained in details for better understanding of the present invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected.

What is claimed is:

1. A management system for managing an information system, comprising:
one or more arithmetic devices; and
one or more storage devices,
wherein the one or more arithmetic devices acquire current configuration information attained from a current configuration of an information system,
wherein the one or more storage devices store therein past configuration information and handling method information,
wherein the past configuration information indicates past configuration case information attained from different past configuration cases for the information system,
wherein the current configuration information and the past configuration information are each constituted of a plurality of items,
wherein the plurality of items are each assigned with a bit,
wherein a value of each bit assigned to each of the plurality of items indicates one of two states defined in each item,
wherein the handling method information associates a relationship between a bit sequence of the current configuration information and a bit sequence of the past configuration case information with a handling method for a configuration error, and
wherein the one or more arithmetic devices:
select past configuration case information from the past configuration information;
select, from the handling method information, a handling method based on the relationship between the bit sequence of the past configuration case information and the bit sequence of the current configuration information; and
present the selected handling method.

2. The management system according to claim 1,
wherein the past configuration case information is failed configuration case information attained from configurations of failed configuration cases,
wherein the handling method information associates a bit sequence of the failed configuration case information with a handling method for a configuration error, and
wherein the one or more arithmetic devices:
select, from the past configuration information, failed configuration case information having a bit sequence that matches a bit sequence of the current configuration information, and
select, from the handling method information, a handling method associated with the bit sequence that matches the bit sequence of the current configuration information.

3. The management system according to claim 1,
wherein the past configuration case information is successful configuration case information attained from configurations of successful configuration cases,
wherein the handling method information associates a bit where bit values differ between a bit sequence of the current configuration information and a bit sequence of the successful configuration case information with a handling method for a configuration error, and
wherein the one or more arithmetic devices:
identify a bit where bit values differ between the bit sequence of the current configuration information and the bit sequence of the successful configuration case information, and
select a handling method associated with the differing bit from the handling method information.

4. The management system according to claim 3,
wherein the one or more arithmetic devices select, from the past configuration information, successful configuration case information having a highest degree of similarity to the bit sequence of the current configuration information.

5. The management system according to claim 2,
wherein the one or more storage devices further store therein second past configuration case information and second handling method information,
wherein the second past case configuration information indicates successful configuration information attained from respective configurations of successful configuration cases of the information system,
wherein the second handling method information associates a bit where bit values differ between a bit sequence of the current configuration information and a bit sequence of the successful configuration case information with a handling method for a configuration error, and
wherein the one or more arithmetic devices:
select, from the second past configuration information, successful configuration case information having a highest degree of similarity to the bit sequence of the current configuration information, if failed configuration case information having a bit sequence that matches a bit sequence of the current configuration information is not detected in the configuration case information;
identify a bit where bit values differ between the bit sequence of the current configuration information and the bit sequence of the successful configuration case information; and
select a handling method associated with the differing bit from the second handling method information.

6. The management system according to claim 1,
wherein the one or more storage devices store therein a model that predicts presence or absence of a configuration error in input data based on a configuration of an information system,
wherein the one or more arithmetic devices:
determine presence or absence of a configuration error in the current configuration information by feeding input data including bit sequences of the current configuration information to the model, and
select past configuration case information from the past configuration information upon determining that a configuration error is present.

7. The management system according to claim 1,
wherein the plurality of items includes:
an item that indicates whether one or more software products have been installed or not; and
an item that indicates whether an operation of one software product of the one or more software products was successfully executed or not.

8. A management method for an information system executed by a management system,
wherein the management system retains past configuration information, handling method information, and current configuration information attained from a current configuration of an information system,
wherein the past configuration information indicates past configuration case information attained from different past configuration cases for the information system,
wherein the current configuration information and the past configuration information are each constituted of a plurality of items,
wherein the plurality of items are each assigned with a bit,
wherein a value of each bit assigned to each of the plurality of items indicates one of two states defined in each item,
wherein the handling method information associates a relationship between a bit sequence of the current configuration information and a bit sequence of the past configuration case information with a handling method for a configuration error, and
wherein the management method comprises:
a step in which the management system selects past configuration case information from the past configuration information;
a step in which the management system selects a handling method based on the relationship between the bit sequence of the past configuration case information and the bit sequence of the current configuration information from the handling method information; and
a step in which the management system presents the selected handling method.
